(19) United States
(12) Patent Application Publication
(10) Pub. No.: US 2020/0125796 A1
(43) Pub. Date: Apr. 23, 2020

(54) Displaying and Editing an Electronic Document

(71) Applicant: HOLDIA OY, Hämeenlinna (FI)

(72) Inventor: Jussipertti PIRHONEN, Tampere (FI)

(73) Assignee: HOLDIA OY, Hämeenlinna (FI)

(21) Appl. No.: 16/604,314

(22) PCT Filed: Apr. 24, 2018
(86) PCT No.: PCT/FI2018/050296

§ 371 Date: Oct. 10, 2019

(30) Foreign Application Priority Data
Apr. 12, 2017 (FI) 20175346

(51) Int. Cl. G06F 40/186; G06F 40/194; G06F 16/176

(52) U.S. Cl. CPC G06F 40/186; G06F 16/176; G06F 40/194

(57) ABSTRACT

An electronic document (40) may be edited by at least two users simultaneously during a session. The two users may be a client and an expert providing a valid document. The client may prefill a document template or provide information to the expert, wherein the expert may complete at least one portion of the electronic document (40). The client may observe the document evolution as the expert completes a portion and the content is updated to the electronic document (40).

### BACKGROUND

Collaborative document editing may be used simultaneously with multiple terminals or having the document displayed at multiple displays simultaneously. One example of documents that may be used or shared is legal documents, wherein the templates may be distributed via the Internet. Lawyers may provide document templates for their clients, wherein the client may fill in the required information and the lawyer may complete the document to confirm its validity and conformance to the client's situation.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

An electronic document may be edited by at least two users simultaneously during a session. The two users may be a client and an expert providing a valid document. The client may prefill a document template or provide information to the expert, wherein the expert may complete at least one portion of the electronic document. The client may observe the electronic document evolution as the expert completes a portion and the content is updated to the electronic document. The expert may use different templates to complete the document, wherein the modification steps are not visible to the client. The expert may edit a text portion confidentially, for example, removing unsuitable information from the text portion before allowing the content to be shown on the electronic document. The system having at least one processor and a memory may detect the information provided by the client and suggest suitable content for the editable text portion.

The electronic document is produced collaboratively and interactively between the client and the expert. Both parties may edit the electronic document, wherein the visibility of the edits by the expert are delayed until the expert allows the edit to appear on the client's electronic document display. The collaboration has different user roles for the client and the expert.

The electronic document collaboration may be used to create valid legal documents in a semi-automated manner. For example, lawyers may produce contracts for various purposes with real time feedback received from the client.

The electronic document may be created in a cloud computing environment, wherein the client may be in a different geographical location than the lawyer. The collaboration enables documents, such as contracts, to be created quickly and effectively, reducing the need for traditional email exchange having multiple draft versions sent back and forth between the client and the lawyer. One example of a service utilizing the solution is a cloud-based legal service. The context of the lawyer-client relationship is used here as an example, not limiting the purpose of contract drafting. In one example, the solution may be used for creating purchase orders or invoices.

Many of the attendant features will be more readily appreciated as they become better understood by reference to the following detailed description considered in connection with the accompanying drawings. The embodiments described below are not limited to implementations which solve any or all the disadvantages of known electronic document collaboration solutions or cloud-based electronic document editing solutions.

### BRIEF DESCRIPTION OF THE DRAWINGS

The present description will be better understood from the following detailed description read in light of the accompanying drawings, wherein

FIG. 1 illustrates schematically one embodiment of the apparatuses;

FIG. 2 illustrates schematically one embodiment of the apparatuses;

FIG. 3 illustrates schematically the steps of a method; and

FIG. 4 illustrates schematically an electronic document with two portions.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

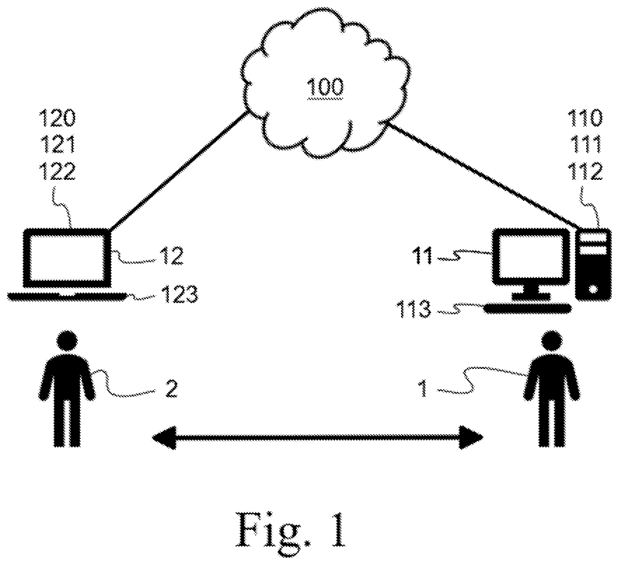

FIG. 1 illustrates schematically one example of the apparatuses. A first user 1, for example, an expert, such as a lawyer, uses a first apparatus 11. In this example, the first apparatus 11 is a desktop computer. The first apparatus 11 comprises a first display 110 and a first user interface 113 for a first user 1 and at least one processor 111 and a memory 112 for storing instructions that, when executed, cause the first apparatus 11 to perform the functionality described hereinafter.

A second user 2, for example, a client uses a second apparatus 12. In this example, the second apparatus 12 is a laptop computer. The second apparatus 12 is connected to the first apparatus 11 via a communication interface. The communication interface may be configured for wired or wireless communication. In this example, both the first apparatus 11 and the second apparatus 12 comprise a communication interface configured to communicate via a cloud computing environment 100, in one example, via the Internet. The second apparatus 12 comprises a second display 120 and a second user interface 123 for the second user 2. Examples of user interfaces 113, 123 are keyboards, speech-to-text devices or imaging devices configured to transform human interaction into text content. The second apparatus 12 comprises at least one processor 121 and a memory 122 for storing instructions that, when executed, cause the second apparatus 12 to perform the functionality described hereinafter.

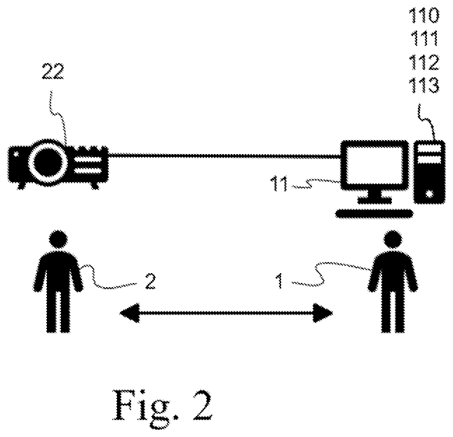

FIG. 2 illustrates schematically one embodiment, wherein the second apparatus 22 is a projector or a display configured to display the electronic document for the second user 2. The first apparatus 11 may be connected to the projector via a cable or via an IP network. The second user 2 may provide instructions to the first user 1 orally or, for example, by a parallel telephone connection.

Although the present examples are described and illustrated herein as being implemented on laptop or desktop computers, the apparatus described is provided as an example and not a limitation. As those skilled in the art will appreciate, the present examples are suitable for application in a variety of different types of apparatuses for creating electronic documents. The exemplary embodiments may be implemented in user equipment, such as servers comprising a suitable user interface, workstations, PCs, laptop computers, handheld devices, smartphones and the like, capable of performing the exemplary embodiments. The displays 110, 120, the projector 22, user interface equipment, such as the keyboard, processors and/or memory components, are examples of means for executing the steps of the method described hereinafter. In one embodiment the first apparatus 11 resides in a cloud computing environment, wherein the first user 1 operates the first apparatus via first user interface 113. The first user interface 113 may be a terminal or any means for entering data digitally for the first apparatus 11 residing in a cloud computing environment, such as keyboard, laptop computer or smartphone. In one embodiment the first apparatus 11 is a distributed system residing partially in a cloud computing environment, wherein the first user interface is 113 within reach of the first user 1.

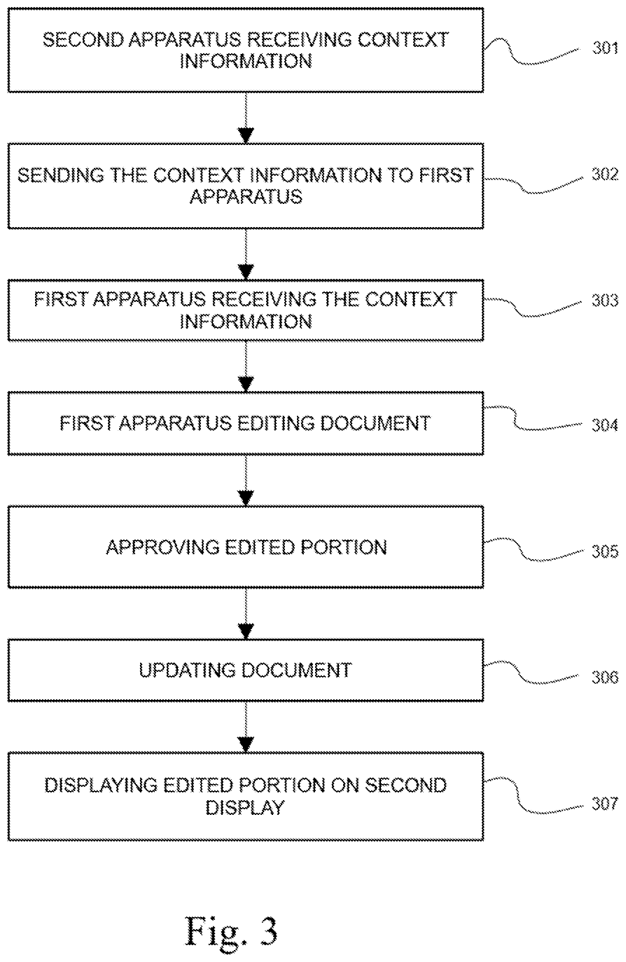

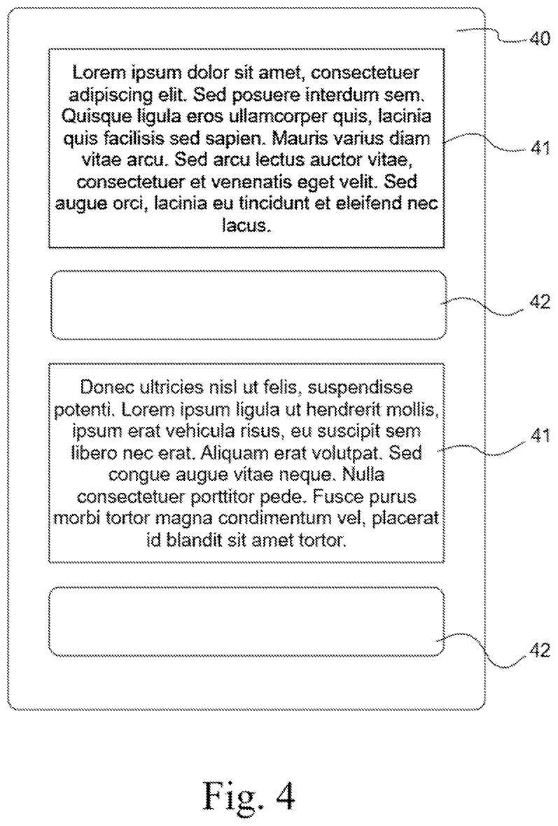

FIG. 3 illustrates the steps of the method, wherein an electronic document 40 is provided comprising a first portion 41 having predefined content and a second portion 42 having editable content. FIG. 4 shows one example of the document 40. The electronic document 40 is, in one example, a text document, a legal document, a contract to be drafted or suchlike. The predefined content of the first portion 41 comprises, for example, text passages that are similar in all document types of the same field. As one example, a purchase agreement may contain phrases, sentences or boilerplates that have been modified to provide maximum benefit for a company. The electronic document 40 may contain multiple instances of the first portion 41, fixed text passages may appear in various places.

The second portion 42 may be blank or prefilled according to the context of the document 40. The second portion comprises, according to one example, the variables of the text, such as name or address information, relationships between parties or negotiated details of the contract. The second user 2, for example, the client may provide information to the second portion 42 and fill in the details. In the example of legal contracts, the content provided by the second user 2 may be unsuitable for obtaining a legally solid document. According to step 301, the second apparatus 12 may be used to insert or edit the second portion 42 of the electronic document 40 or context information relating to the second portion 42 as a response to an input received from the second user interface 123. In one example, the first apparatus 11 inserts the content to the second portion 42 as a response to the instructions received from the second user 2.

In step 302, the electronic document 40 is sent to the first apparatus 11 via the communication interface. In one example, the document creation is initiated by the second apparatus 12 and by the second user 2. Alternatively, or in addition, the document creation is initiated by the first apparatus 11 and by the first user 1. The template for the electronic document 40 may reside in a cloud computing environment or in the first apparatus 11. In step 303, the first apparatus 11 receives the context information for the second portion 42 via the communication interface. The context information is, in one example, prefilled content on the second portion 42 of the electronic document 40 that may be inserted by the second user 2.

In step 304, the first apparatus 11 is editing the second portion 42 of the electronic document 40 as a response to the context information via the first user interface 113. In step 305, the first apparatus 11 receives via the first user interface 113 an approval for updating the document 40 on the second apparatus 12. The first user 1 may edit the document 40 and use necessary templates that may contain confidential information not suitable for the case or context of the document 40. As a response to receiving the approval, the first apparatus 11 updates the second portion 42 of the electronic document 40 in step 306. In step 307, the electronic document 40 is displayed on the second display 120 of the second apparatus 12 or, according to an embodiment, on the second apparatus 22, such as the projector.

In one embodiment, the first apparatus 11 is configured to detect at least a portion of the context information from the second portion 42. The first apparatus 11 may detect a similarity between the provided context information and content stored on a template database. The first apparatus 11 may comprise a neural network configured to detect text patterns and propose content from the template database. The template database may reside on the first apparatus 11 or in the cloud computing environment. The first apparatus 11 is configured to retrieve a text template from the template database as a response to the context information, for example, based on the detected similarity. The first apparatus 11 is configured to insert the text template portion to the second portion 42 before editing the second portion 42 of the electronic document 40. In one embodiment, the first apparatus 11 is configured to insert the text template portion to the second portion 42 before receiving the approval for updating the electronic document 42 on the second apparatus 40. The first apparatus 11 may provide an autofill function based on the detected context information, further automating the drafting process of the document 40.

The first user 1 and the second user 2 may have different roles. According to one example, the first user 1 may use the method for providing expert services over a distance, for example, over the Internet. The document 40 may be drafted in real time during a single session, wherein the second user 2—for example, the client—may receive a contract or any other document that has been approved by a professional expert. For example, a legal practitioner may be available regardless of the location, thus people may save time and travel expenses.

An example discloses a method comprising: a first apparatus having a first display and a first user interface for a first user and at least one processor and a memory for storing instructions that, when executed, cause the steps of the first apparatus for: providing an electronic document comprising a first portion having predefined content and a second portion having editable content; and editing the second portion of the electronic document as a response to an input received from the user interface; wherein the method further comprises: a second apparatus being connected to the first apparatus, having a second display and a second user interface for a second user and at least one processor and a memory for storing instructions that, when executed, cause the steps of the second apparatus for receiving the electronic document and displaying the electronic document on the second display, The method comprises the steps of the second apparatus receiving context information via the second user interface and sending the context information to the first apparatus; causing the first apparatus to: receive the context information; edit the second portion of the electronic document as a response to the context information; receive an approval for updating the electronic document on the second apparatus via the user interface; update the second portion of the electronic document as a response to the approval for updating; and display the electronic document on the second display. In an embodiment, the method comprises the first apparatus detecting at least a portion of the context information, detecting similarity in content stored on a template database, retrieving a text template from the template database as a response to the context information and inserting the text template portion to the second portion before editing the second portion of the electronic document. In an embodiment, the method comprises the first apparatus detecting at least a portion of the context information, detecting similarity in content stored on a template database, retrieving a text template from the template database as a response to the context information and inserting the text template portion to the second portion before receiving the approval for updating the electronic document on the second apparatus.

In addition, or alternatively, an apparatus is disclosed, comprising: a first display and a first user interface for a first user and at least one processor and a memory for storing instructions that, when executed, cause the apparatus to: provide an electronic document comprising a first portion having predefined content and a second portion having editable content; and edit the second portion of the electronic document as a response to an input received from the user interface. The apparatus comprises at least one processor and a memory for storing instructions that, when executed, cause the apparatus to: receive context information from a second apparatus; edit the second portion of the electronic document as a response to the context information; receive an approval for updating the electronic document on the second apparatus via the user interface; update the second portion of the electronic document as a response to the approval for updating; and send the second portion to be displayed in the electronic document at the second display of the second apparatus. In one embodiment, the at least one processor and a memory for storing instructions that, when executed, cause the apparatus to: detect at least a portion of the context information, detect similarity in content stored on a template database, retrieve a text template from the template database as a response to the context information and insert the text template portion to the second portion before editing the second portion of the electronic document. In one embodiment, the at least one processor and a memory for storing instructions that, when executed, cause the apparatus to: detect at least a portion of the context information, detect similarity in content stored on a template database, retrieve a text template from the template database as a response to the context information and insert the text template portion to the second portion before receiving the approval for updating the electronic document on the second apparatus.

Alternatively, or in addition, a system is disclosed, comprising: a first apparatus having a first display and a first user interface for a first user and at least one processor and a memory for storing instructions that, when executed, cause the first apparatus to: provide an electronic document comprising a first portion having predefined content and a second portion having editable content; and edit the second portion of the electronic document as a response to an input received from the user interface; a second apparatus being connected to the first apparatus via a communication interface, having a second display and a second user interface for a second user and at least one processor and a memory for storing instructions that, when executed, cause the second apparatus to: receive the electronic document and display the electronic document on the second display. The system further discloses causing the second apparatus to: receive context information via the second user interface and send the context information to the first apparatus via the communication interface; and causing the first apparatus to: receive the context information via the communication interface; edit the second portion of the electronic document as a response to the context information; receive an approval for updating the electronic document on the second apparatus via the user interface; update the second portion of the electronic document as a response to the approval for updating; and display the electronic document on the second display. In one embodiment, the at least one processor and a memory for storing instructions that, when executed, cause the first apparatus to detect at least a portion of the context information, detect similarity in content stored on a template database, retrieve a text template from the template database as a response to the context information and insert the text template portion to the second portion before editing the second portion of the electronic document. In one embodiment, the at least one processor and a memory for storing instructions that, when executed, cause the first apparatus to detect at least a portion of the context information, detect similarity in content stored on a template database, retrieve a text template from the template database as a response to the context information and insert the text template portion to the second portion before receiving the approval for updating the electronic document on the second apparatus. In one embodiment, the first apparatus resides in a cloud computing environment.

Alternatively, or in addition, the controlling functionality described herein can be performed, at least in part, by one or more hardware components or hardware logic components. An example of the control system described hereinbefore is a computing-based device comprising one or more processors which may be microprocessors, controllers or any other suitable type of processors for processing computer-executable instructions to control the operation of the apparatus to edit, display and/or transmit the document or provide connection to other apparatuses. The computer-executable instructions may be provided using any computer-readable media that is accessible by a computing-based device. Computer-readable media may include, for example, computer storage media, such as memory and communications media. Computer storage media, such as memory, includes volatile and non-volatile, removable and non-removable media implemented in any method or technology for storage of information, such as computer-readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device, it will be appreciated that the storage may be distributed or located remotely and accessed via a network or other communication link, for example, by using a communication interface.

The methods described herein may be performed by software in machine-readable form on a tangible storage medium, e.g. in the form of a computer program comprising computer program code means adapted to perform all the steps of any of the methods described herein when the program is run on a computer and where the computer program may be embodied on a computer-readable medium. Examples of tangible storage media include computer storage devices comprising computer-readable media, such as disks, thumb drives, memory etc., and do not only include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Any range or device value given herein may be extended or altered without losing the effect sought.

Although at least a portion of the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method comprising:
a first apparatus (11) having a first display (110) and a first user interface (113) for a first user (1) and at least one processor (111) and a memory (112) for storing instructions that, when executed, cause the steps of the first apparatus (11) for:
providing an electronic document (40) comprising a first portion (41) having predefined content and a second portion (42) having editable content; and
editing the second portion (42) of the electronic document (40) as a response to an input received from the first user interface (113);
wherein the method further comprises:
a second apparatus (12) being connected to the first apparatus (11), having a second display (120) and a second user interface (123) for a second user (2) and at least one processor (121) and a memory (122) for storing instructions that, when executed, cause the steps of the second apparatus (12) for:
receiving the electronic document (40) and displaying the electronic document (40) on the second display (120),
wherein the electronic document (40) is displayed simultaneously on the first display (110) and the second display (120), characterized by:
the second apparatus (12) receiving (301) context information relating to the second portion (42) via the second user interface (123) and sending (302) the context information to the first apparatus (11), wherein the context information comprises textual prefilled content on the second portion (42) of the electronic document (40);
causing the first apparatus (11) to:
receive (303) the context information;
edit (304) the second portion (42) of the electronic document (40) as a response to the context information;
receive an approval (305) for updating the electronic document (40) on the second apparatus (12) via the first user interface (113); update (306) the second portion (42) of the electronic document (40) as a response to the approval for updating; and
display (307) the electronic document (40) on the second display (120).

2. A method according to claim 1, characterized by the first apparatus (11) detecting at least a portion of the context information, detecting similarity in content stored on a template database, retrieving a text template from the template database as a response to the context information and inserting the text template portion to the second portion (42) before editing the second portion (42) of the electronic document (40).

3. A method according to claim 1, characterized by the first apparatus (11) detecting at least a portion of the context information, detecting similarity in content stored on a template database, retrieving a text template from the template database as a response to the context information and inserting the text template portion to the second portion (42) before receiving the approval for updating the electronic document (40) on the second apparatus (12).

4. An apparatus comprising:
a first display (110) and a first user interface (113) for a first user (1) and at least one processor (111) and a memory (112) for storing instructions that, when executed, cause the apparatus to:
provide an electronic document (40) comprising a first portion (41) having predefined content and a second portion (42) having editable content; and
edit the second portion (42) of the electronic document (40) as a response to an input received from the first user interface (113), characterized in that the at least one processor (111) and a memory (112) for storing instructions that, when executed, cause the apparatus to:
receive context information relating to the second portion (42) from a second apparatus (12), wherein the context information comprises textual prefilled content on the second portion (42) of the electronic document (40) being displayed simultaneously on the first display (110) and the second display (120);
edit the second portion (42) of the electronic document (40) as a response to the context information;
receive an approval for updating the electronic document (40) on the second apparatus (12) via the first user interface (113);
update the second portion (42) of the electronic document (40) as a response to the approval for updating; and
send the second portion (42) to be displayed in the electronic document (40) at the second display (120) of the second apparatus (12).

5. An apparatus according to claim 4, characterized in that the at least one processor (111) and a memory (112) for storing instructions that, when executed, cause the apparatus to: detect at least a portion of the context information, detect similarity in content stored on a template database, retrieve a text template from the template database as a response to the context information and insert the text template portion to the second portion (42) before editing the second portion (42) of the electronic document (40).

6. An apparatus according to claim 4, characterized in that the at least one processor (111) and a memory (112) for storing instructions that, when executed, cause the apparatus to: detect at least a portion of the context information, detect similarity in content stored on a template database, retrieve a text template from the template database as a response to the context information and insert the text template portion to the second portion (42) before receiving the approval for updating the electronic document (40) on the second apparatus (12).

7. A system comprising:
a first apparatus (11) having a first display (110) and a first user interface (113) for a first user (1) and at least one processor (111) and a memory (112) for storing instructions that, when executed, cause the first apparatus (11) to:
provide an electronic document (40) comprising a first portion (41) having predefined content and a second portion (42) having editable content; and
edit the second portion (42) of the electronic document (40) as a response to an input received from the first user interface (113);
a second apparatus (12) being connected to the first apparatus (11) via a communication interface, having a second display (120) and a second user interface (123) for a second user (2) and at least one processor (121) and a memory (122) for storing instructions that, when executed, cause the second apparatus (12) to:
receive the electronic document (40) and display the electronic document (40) on the second display (120);
wherein the electronic document (40) is displayed simultaneously on the first display (110) and the second display (120), characterized by causing the second apparatus (12) to:
receive context information relating to the second portion (42) via the second user interface (123) and send the context information to the first apparatus (11) via the communication interface, wherein the context information comprises textual prefilled content on the second portion (42) of the electronic document (40); and
causing the first apparatus (11) to:
receive the context information via the communication interface;
edit the second portion (42) of the electronic document (40) as a response to the context information;
receive an approval for updating the electronic document (40) on the second apparatus (12) via the first user interface (113);
update the second portion (42) of the electronic document (40) as a response to the approval for updating; and
display the electronic document (40) on the second display (120).

8. A system according to claim 7, characterized in that the at least one processor (111) and a memory (112) for storing instructions that, when executed, cause the first apparatus (11) to detect at least a portion of the context information, detect similarity in content stored on a template database, retrieve a text template from the template database as a response to the context information and insert the text template portion to the second portion (42) before editing the second portion (42) of the electronic document (40).

9. A system according to claim 7, characterized in that the at least one processor (111) and a memory (112) for storing instructions that, when executed, cause the first apparatus (11) to detect at least a portion of the context information, detect similarity in content stored on a template database, retrieve a text template from the template database as a response to the context information and insert the text template portion to the second portion (42) before receiving the approval for updating the electronic document (40) on the second apparatus (12).

10. A system according to claim 7, characterized in that the first apparatus (11) resides in a cloud computing environment.
